(19) United States
(12) Patent Application Publication
(10) Pub. No.: US 2013/0031096 A1
(43) Pub. Date: Jan. 31, 2013

(54) SYSTEM AND METHOD FOR THE INTELLIGENT SUGGESTION AND EVALUATION OF CONTENT

(71) Applicants: Mark SUTTER, Farmington, CT (US); Simon YELSKY, Montvale, NJ (US); Jeff WEINSTEIN, Ocean, NJ (US)

(72) Inventors: Mark SUTTER, Farmington, CT (US); Simon YELSKY, Montvale, NJ (US); Jeff WEINSTEIN, Ocean, NJ (US)

(21) Appl. No.: 13/559,945

(22) Filed: Jul. 27, 2012

Related U.S. Application Data
(60) Provisional application No. 61/512,960, filed on Jul. 29, 2011.

(51) Int. Cl. G06F 17/30

(52) U.S. Cl. 707/737; 707/E17.014; 707/E17.033

(57) ABSTRACT

A system and method for analyzing search sessions including recording a plurality of search sessions, the search sessions compiled into a plurality of search clusters based on a commonality of search terms used across sessions in each cluster, and calculating a rating for each of the plurality of search clusters based on the success of the search session in yielding usable search results.

### CROSS-REFERENCE TO RELATED APPLICATION

This application claims the benefit of U.S. Provisional Application No. 61/512,960, filed Jul. 29, 2011, which is hereby incorporated by reference in its entirety herein.

### FIELD OF THE INVENTION

This invention relates to systems and methods that analyze searching to, for example, facilitate the creation of new content in a knowledge management environment with the intention of this content being used for search.

### BACKGROUND

Knowledge management and searching, e.g., storing and searching for documents stored in an electronic database, is a central part of the operation of modern enterprises. Optimization in any part of the creation and retrieval process is therefore of prime importance. One issue with current knowledge management systems is that much of the created content is not content that is being searched for. Creation of this content is not only wasted effort, it may create a more negative search environment as the results (e.g., a list of documents returned to a user) may be flooded with answers for which nobody is asking the question. Additionally, certain searches that are frequently performed may continuously yield irrelevant or negative search results that may frustrate a user trying to find the solution to a problem.

While modern search engines do a reasonable job trying to find the correct answer for questions, it is undoubtedly true that removal of content that is not likely to be searched for can only help the search experience. And while current search engines do try to improve the rank of content that gets used and de-emphasize (e.g., lower the rank of) content that is not used, according to Bayesian statistics if content was never searched for it is not likely to get searched for or used in the future. Also, content relevant to certain searches may simply not exist and it may be beneficial to create such content.

### SUMMARY

A good resource exists in the log of previous or existing searches that may be used in the creation and contribution of further content. The log may be used in the evaluation of new content that is being authored, and also in suggesting new content from the evaluation of past searches against existing content.

For example, a purpose of the various embodiments of the present invention may be to create, modify or edit content responsive to the needs, wants, and desires of users using a knowledge management system. If a user is searching for knowledge (e.g., a document) but cannot find it, then that user, or an administrator monitoring user searches, may want to create knowledge responsive to the search. Alternatively, an administrator or user may determine that knowledge already existing on the system is never searched for and can, therefore, be deleted.

Embodiments of the present invention may involve enhancing the workflow of content creation, and may help transform past searches into new content, and provide tools to help in creation of new content that addresses an existing demand for it.

One embodiment of the present invention may use past searches or search sessions to evaluate the usefulness of knowledge within a knowledge management system. Usefulness may be judged or determined by, for example, how many times knowledge is searched for, how many times the knowledge is used or marked as useful, and whether the knowledge is relevant or responsive to the search performed.

Another embodiment may use past searches or search sessions to assist in determining the usefulness of content in a document to said knowledge management system. A knowledge management system may contain content that is never searched for, or content that is never used when yielded as a search result. This content may not be useful to the knowledge management system and may be expired (e.g., deleted). Expiring or deleting non-useful content may help keep the knowledge management system concise and better able to provide useful content to users in search sessions.

Another embodiment may use past searches or search sessions to assist in suggesting new content to be created for a knowledge management system in order to address the need for content being searched for by a search or search session. For example, users of a knowledge management system may perform searches, but the search may not yield content (e.g., search results) relevant to the search, or may not yield any content at all. An embodiment of the present invention may assist in the creation of new content applicable and responsive to these unsuccessful searches.

Another embodiment may use past searches or search sessions to assist in evaluating the applicability of new content being added to the knowledge management system to the past searches or search sessions performed. For example, an author may create content and then evaluate that content against past searches or search sessions to determine whether that content is applicable to the content that users of the knowledge management system are searching for.

Another embodiment may include a system and method for evaluating and modifying content being created in a knowledge management system. The evaluation may be performed or executed against past searches in order to determine the usefulness, relevance, or responsiveness of the content being considered. For example, as an author is starting a new article the author may determine that the content the author is currently creating is not being searched for (e.g., records of current searches by others show a low or nonexistent number of searches for this content) and, therefore, the author should not bother writing it. In addition, an embodiment may provide a method and system to generate a report suggesting future content such as articles to be written using past searches.

One embodiment includes a method of analyzing search sessions including recording a plurality of search sessions, the search sessions compiled into a plurality of search clusters based on a commonality of search terms used across sessions in each cluster, and calculating a rating of each of the plurality of search clusters based on the success of the search session in yielding usable search results. In certain embodiments, the rating may be calculated as a percentage. In other embodiments, the rating may be calculated as a fraction. In certain embodiments the rating may be calculated based on the measured success of the search, the success being measured by explicit user input, by implicit user action (e.g., clicking on a solution) or both. (When used herein “clicking” or indicating may include a user indicating, using a pointing device such as a mouse or touchscreen, a certain on-screen item, such a button or document title or description.) In certain embodiments, the method may include compiling the plurality of search clusters into an index, the index assisting in the creation of new content for the knowledge management system to address the need for the content being searched for by the search sessions. For example, when a user enters the knowledge management system he might click on or otherwise indicate a link saying “suggest new solutions”. This would then cause to be listed groupings of search sessions, each grouping being, for example, a cluster of related search sessions clustered together by the similarity or commonality of terms used to search and/or the solution content (e.g. search results) viewed in those search sessions. The index may be weighted or filtered based on the calculated rating of each search.

The search sessions or clusters may be displayed or listed in order of how successful the sessions or clusters are, e.g., how responsive the sessions or clusters are in retrieving documents. The groupings or clusters may be listed, for example, in order of how frequently the sessions in that cluster were evaluated to have, for example, a negative result (e.g., evaluated to not have had a view of a solution that resolved the issue). The listing of search results may be in order of how responsive a search result is to each search session in each cluster.

In some embodiments, searches or clusters for a certain period of time (e.g., the last week) may be displayed. A user may click on or otherwise indicate a search or cluster, and in response expanded information may be displayed. E.g., a user may click on a cluster to view the individual searches with search terms within that cluster.

In certain embodiments, the system may also list for each cluster the top solutions or search results matching the topics in that cluster. Also, in certain embodiments, the system may additionally list for each session in a cluster the top solution the system would have suggested for that search session. For each session the user would then be able to click or otherwise indicate if the suggested solution (e.g., search result) solved the issue, or, alternately, click another one of the solutions viewed in the session or one of the top solutions for the cluster.

In certain embodiments, if a solution is selected during a search session, phrases or terms used in the search may then be evaluated either by the user or by the system against the solution. If the solution would not score well against the search phrase then that search phrase may, for example, be added to a searchable field within the solution so that, in the future, that solution would be returned more highly for that search.

In certain embodiments, the user may also have the option of clicking or otherwise indicating “no solution matches, create new” which may pick the search phrase with the most terms to use as a title of the new solution, add the other phrases to the details field, and allow the user to modify that new solution and/or save it into a state for a future modification by an author. That solution may then be available for selection as the solving solution (e.g., relevant/responsive search result) for subsequent search sessions, and that action of selecting it may add the terms from that search session into that solution as well.

One embodiment of the invention includes a method of evaluating the applicability of a document being added to a knowledge management system, including recording a plurality of search sessions, the search sessions compiled into a plurality of search clusters based on a commonality of search terms used across sessions in each cluster, receiving a document, and evaluating the document against the plurality of search clusters to determine for each search cluster how likely a search using the search cluster is to rank the document high in the search or above a certain threshold ranking (in this context, “above” a threshold ranking typically means lower in number, e.g., a ranking of 1 is higher than ranking of 2). A search using a cluster may mean using a typical set of search terms which is in the cluster, a representative search returned by searches within the cluster, or some other search.

Another embodiment may provide to, for example, an author of the article an estimate of how often a particular article will be searched for based on past search sessions, and show an evaluation of the article based on several criteria, including how many previous sessions could have been resolved using this solution, where this solution, document or article would rank among existing solutions using this metric, and listing or displaying the titles of other solutions or documents that would cluster with this one and how they would rank. For example, in certain embodiments, the evaluation of the document may list or display a number of search sessions the document is responsive to. This list may provide an author or user with an estimate of how useful the document is.

One embodiment includes a method of using search sessions in a knowledge management system, including recording a plurality of search session, the search sessions compiled into a plurality of search clusters based on a commonality of search terms used across sessions in each cluster, rating each of the plurality of search clusters based on the success of the search session in yielding usable search results; and compiling the plurality of search clusters into an index, the index assisting in determining the usefulness of content in a document to the knowledge management system. In certain embodiments, usefulness may be measured by how responsive the content in the document is to the search performed. Responsiveness may be measured by explicit user action, implicit user action, or both explicit and implicit user action. For example, in certain embodiments, a user may indicate that a document was useful by clicking on a button or otherwise explicitly indicating that the document was responsive to the search conducted. In certain embodiments, usefulness may be determined by whether or not the document was viewed by the user during a search session.

One embodiment includes a knowledge management system, including a memory to store a plurality of search sessions, and a processor to record a plurality of search sessions, the search sessions compiled into a plurality of search clusters based on a commonality of search terms used across sessions in each cluster and calculate a rating for each of the plurality of search clusters based on the success of the search session in yielding useable search results. In certain embodiments, the memory may be connected or otherwise in communication with a server. In certain embodiments, the system may include at least one user computing devices or terminals connect to or otherwise in communication with the memory, processor and server. In certain embodiments the server may, for example, operate one or more interfaces. The interfaces may also be operated by the user computing devices. For example, in certain embodiments, the server or user computing device may operate a search portal interface for, for example, searching and viewing documents, articles, or solutions on the knowledge management system. In certain embodiments, the server or user computing device may operate a knowledge management interface for, for example, adding or editing a document, article or solution on the knowledge management system. In certain embodiments, the knowledge management interface may, for example, be used for managing existing content and/or for creating new content on a knowledge management system. In certain embodiments, the memory may include a database or memory storage unit.

### BRIEF DESCRIPTION OF THE DRAWINGS

The principles and operation of the system, apparatus, and method according to embodiments of the present invention may be better understood with reference to the drawings, and the following description, it being understood that these drawings are given for illustrative purposes only and are not meant to be limiting.

FIG. 1 is a flow chart illustrating a method of analyzing search sessions according to embodiments of the present invention;

FIG. 2 is a flow chart illustrating a method of evaluating the applicability of a document according to embodiments of the present invention;

FIG. 3 is a block diagram of a knowledge management system according to embodiments of the invention;

FIG. 4 is a high level block diagram of an exemplary computing device according to embodiments of the present invention; and

FIGS. 5-7 are example displays on a monitor of a user computing device according to embodiments of the present invention.

For simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate correspondence or analogous elements throughout the serial views.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing”, “computing”, “storing”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. Such apparatuses may be specially constructed for the desired purposes, or may comprise controllers, computers or processors selectively activated or reconfigured by a computer program stored in the computers. Such computer programs may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus. It will be appreciated that a variety of programming languages may be used to implement the teachings of the invention as described herein.

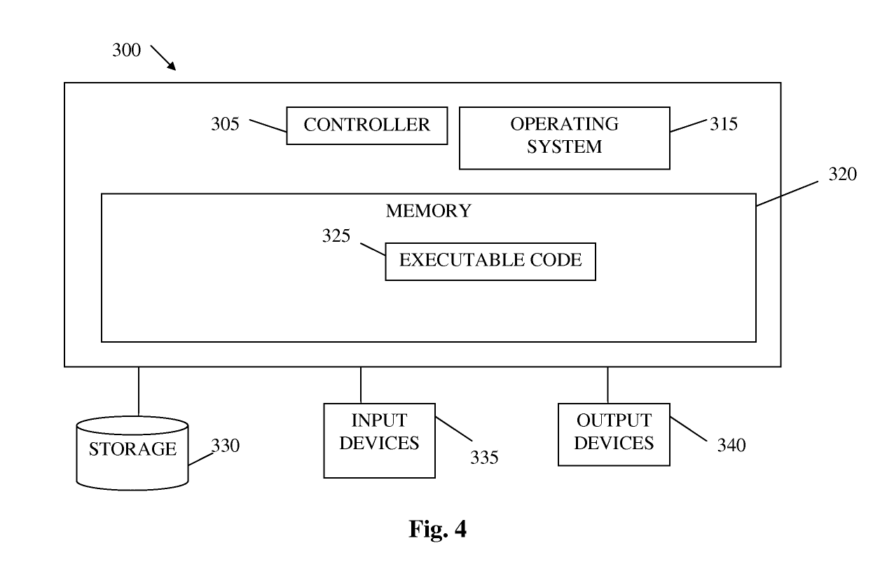

Unless specifically stated otherwise, as apparent from the following discussions, it is appreciated that a session or search session, as it is referred to herein, is an event or series of computer processing steps occurring when a user accesses a search portal or program, executes or causes to be executed a set of searches (typically for documents stored on one or more electronic databases, typically accessible via a network), and possibly solution or search result views, opens tickets, or other action for the purpose of resolving a particular issue. In certain embodiments, a search session or search may be performed by, for example, a computer processor such as controller 305 (FIG. 4). In certain embodiments, the search session may be determined to start or end by using a hypertext transfer protocol (HTTP) session identifier, which may, for example, change for a user each time the user accesses the search portal interface. In other embodiments other ways of determining where a particular search session starts or ends for a user may also be used. For example, a search may involve a user typing in a set of search terms, a computer using those terms to search over a set of documents, and the computer returning to the user a list of documents including the search terms, derivations of the search terms, or synonyms of the search terms.

In certain embodiments, a search session, as it is referred to herein, may be an individual search conducted by a user, or it may be a series of individual searches. In certain embodiments, data associated with each search session may include the terms or phrases used in each search, the results of each search, user input as to whether the search yielded useful results, and/or user input as to whether or not a particular result was useful. Additional data that may be associated with a search may include an identification of the user who executed the search, the time and date the search was executed, and user feedback regarding the success of the search. A search session or a search may be defined or labeled by the search terms used for the search, possibly with connectors. Other data may be included in a search or search session, such as results; however, when discussed herein a search may include a query in the form of terms without corresponding results.

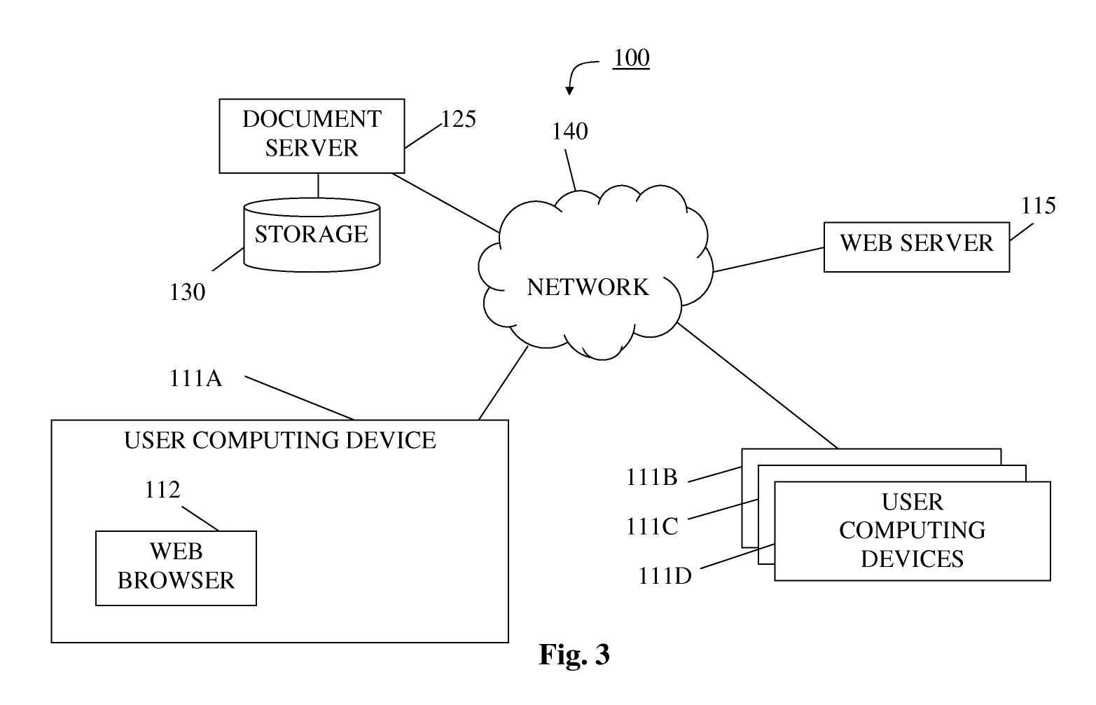

An article, document, item, solution, result or search result, as it is referred to herein, may be a piece or item of content which is produced or yielded in a search, or is otherwise returned as, for example, a single link in a listing of search results. In certain embodiments the articles, documents, items, solutions, results or search results may be stored in, for example, storage 130 (FIG. 3). Unless specifically stated otherwise, the term knowledge, as used herein, may represent an article, document, solution, result, search result or otherwise content contained on the knowledge management system. For example, documents or other items searched may be text documents such as created using a word processing or other program, documents stored in .pdf format, databases (e.g., .xls documents), presentations (e.g., stored in .ppt format) or other documents. A search typically involves a user entering search terms and possibly modifiers (e.g., “‘patent’ and ‘inventor’) into a search program, and the search program returning a list, typically ordered according to some measure of relevance, of documents in a certain domain or database, relevant to the search terms.

In certain embodiments, a user or administrator of the knowledge management system may add, edit, or delete knowledge (e.g., documents) from the knowledge management system. Adding, editing or deleting knowledge from the knowledge management system may, in some instances, change or modifying the rating of a search, search session or search cluster.

A cluster, as it is referred to herein, may be, for example, a cluster, array, aggregate, assemblage, grouping, set, or package of search sessions, search articles or both. A cluster may be a group of sets of search terms which, while having different terms, are meant to search for more or less the same thing. For example, a cluster may include the three search sessions, each search session represented by a set of search terms (a search session may include data other than or in addition to search terms):
children's museum art
child art education museum
child drawing museum
   as each of the above three sets of search terms search for or result in search results for more or less the same set of documents.

In certain embodiments, clusters may be formed or created by, for example, a processor such as controller 305 (FIG. 4) or other processor on document server 125 (FIG. 3) or user computing devices 111A-D (FIG. 3). In certain embodiments, data for each cluster may be stored on, for example, storage 130 (FIG. 3).

In some embodiments, a cluster may be a set of items or search sessions that are determined to be related using standard industry search clustering techniques. For example, cluster analysis, or clustering, may be the task of assigning a set of objects into groups (e.g., clusters) so that the objects in the same cluster are more similar (in some sense) to each other than to those in other clusters. Clustering may be performed by, for example, various algorithms or vector algebra, where each item in the set or cluster is defined as a term vector, wherein each word or term is a dimension for this vector space. In certain examples, the count of that term in the item being clustered is the magnitude of the vector in that dimension, and the similarity between two items is defined to be the dot product of the vectors of those two items, which will always be a number between zero and one. That is, cluster analysis is an exploratory data analysis tool which aims at sorting different objects into groups in a way that the degree of association between two objects is maximal if they belong to the same group and minimal otherwise. In certain embodiments, the clusters can be simply defined as sets of items where the similarity score exceeds some defined threshold, but clusters can also be defined using other techniques such as advanced multi-dimensional peak fitting techniques taken from mathematics or physics.

In certain embodiments, the clusters may be grouped together into a plurality of clusters. Each cluster in a plurality of clusters may be related such as, for example, in the commonality of search terms used or based on the usefulness or applicability of the content being searched for in each of the search sessions compiled in each cluster.

In other embodiments, each cluster in a plurality of cluster may be related in terms of the success or non-success of each search session in obtaining a relevant or useful search result. By grouping clusters together based on the success of each search session or search cluster in yielding a useful result, a need for new content may be identified. For example, the cluster or plurality of clusters may represent unsuccessful attempts by users of the knowledge management system to find results useful to the search terms or phrases used in the search session. An administrator or user of the system may then identify the unsuccessful attempts and create content to add to the system that would be useful or relevant to those searches. Alternatively, in other embodiments, an administrator or user may edit or modifying existing content to be useful or relevant to those searches. Clusters may be grouped together using one factor or may be grouped together using multiple factors.

In certain embodiments, clustering may be performed or executed by, for example, a processor such as, for example, controller 305 (FIG. 4) or other processor operating on, for example, document server 125 (FIG. 3). In some embodiments, clustering may be performed or executed on a regular basis such as, for example, monthly, weekly, daily, or hourly. In some embodiments, a user or administrator of the knowledge management system may manually initiate or execute clustering.

Recording, as it is referred to herein, may be, for example, recording, saving or logging a search session or search cluster on a database (e.g., hard drive, flash drive, or other suitable database) such as, for example, a storage 130 (FIG. 3), that may be maintained on a server (e.g., document server 125 (FIG. 3)). Document server 125 may operate, for example, a knowledge management system, and may evaluate searches and/or evaluate documents, as described herein. The recording or logging may be performed by, for example, a processor such as, for example, controller 305 (FIG. 4) or other processor operating on, for example, document server 125 (FIG. 3).

A commonality of search terms, as it is referred to herein, may be, for example, a list or grouping of words, terms or phrases that have the same or similar meaning within the context they are being used.

A rating, as it is referred to herein, may be, for example, a numerical value (e.g., a percentage, fraction, whole number, or other integer), possibly based on parameters set by an administrator or user of the knowledge management system. Embodiments of the invention may include rating an individual search, rating a search session, or rating a search cluster. In some embodiments, the rating of a search may be dependent on the ratings of the underlying individual search sessions conducted by users. In some embodiments, the rating of a search cluster may be dependent on the ratings of the underlying search sessions and individual searches.

In certain embodiments the rating may indicate how successful a search was in yielding useful or relevant results. As used herein, a useful or relevant search result may be, for example, a result that is responsive to a question being asked or is relevant or responsive to the search terms or search phrases used. For example, a search that does not yield any results, any useful results or any relevant results may be considered an unsuccessful search and may be given, for example, a low rating. A search that yields highly useful, responsive and/or relevant search results may be given, for example, a high rating.

A search (e.g., a specific set of search terms) may be rated based on individual search sessions or search instances, each session or instance being a user performing a search using the search terms. The rating for a search session or term may be a binary rating (e.g., either good or bad, useful or not useful, relevant or irrelevant), and the rating for the search may be an aggregate of the binary ratings for sessions, e.g., the percentage of search instances that are “good”. For example, a rating for a search may be a percentage of the search sessions using the search terms that are “good” or otherwise positive. If a search including the terms (bicycle Cleveland) is performed 100 times by various users over a document set, and 34 of those users report “positive” and the remainder report “negative”, the rating may be 34, or 34%. A binary rating for a session or instance may be produced, for example, when a user executes a search yielding search results, opens or views a search result and explicitly indicates (e.g., by providing input rating the search to the system) whether the search result is good/bad, relevant/irrelevant, or useful/not useful. In some embodiments, the rating may not be binary and may be based on pre-defined rules of the knowledge management system that rate a search according to implicit user actions occurring during the search as described in more detail below. A binary rating may be based on implicit input, described elsewhere herein. For example, the fact that a user did not review any documents returned by the search (or that no documents were returned) may equal “bad” and the fact that a user reviewed one or more documents may equal “good”. Other methods of rating a search may be used. Typically, the result ultimately displayed to the user is the success of search clusters, where the rating of a cluster is derived from the ratings of the searches within the clusters.

Unless specifically stated otherwise, as apparent from the following discussions, it is appreciated that an index, as it is referred to herein, may be, for example, a listing, report or otherwise a compilation of information or data. In certain embodiment, the index may be stored on, for example, storage 130 (FIG. 3) or storage 330 (FIG. 4).

Unless specifically stated otherwise, as apparent from the following discussions, it is appreciated that the term weighted, as it is used to herein, may refer to, for example, giving preferential treatment to, or emphasis on, particular data, information, or results. Weighting may be done by multiplying a factor or input with a weight. For example, an index of compiled searches or search sessions may be weighted to emphasize or identify those searches that were rated as unsuccessful, nonresponsive or irrelevant. In another example, the solution or result for each search session may be weighted to emphasize or identify those solutions that are most relevant to the search performed.

Some embodiments of the system and method as discussed herein may be used, for example, with a search system on a closed, typically private or enterprise database (e.g., a specific medical journal's database of articles) such as shown in, for example, FIG. 3. In other embodiments a public search engine may be used for searching publicly available documents, e.g. available via (“on”) the Internet. The purpose might be different when used with a public database, such as providing estimates on how many hits might be expected on a particular piece of content. A public search engine typically operates in a somewhat competitive environment as opposed to a private system (e.g., the public system has multiple pieces of content trying to answer the question coming from different authors who all want to get the hit). Thus it is possible for an embodiment to suggest adding particular words more often into content so that the content will beat other existing content for the most common searches.

Certain embodiments may include or operate with a basic knowledge authoring system. This system may, for example, allow a user to author or import individual solutions, articles or documents that are then made available for searching by persons for whom that content may be useful. This system may also allow a user to edit articles or documents on the knowledge management system. In certain embodiments, the system may include, for example, a repository (e.g., database(s), hard drive(s), flash drive(s), server(s) or other device(s) for storing data) of that knowledge such as, for example, storage 130 (FIG. 3), an interface such as, for example, a search portal interface, for searching and viewing the knowledge, and an interface such as, for example, a knowledge management interface, for adding and/or editing that knowledge. In certain embodiments, the search portal interface and/or knowledge management interface may be operated by, for example, web browser 112 located on user computing device 111A-D, or may be operated by a browser on a server such as, for example, server 125 (FIG. 3). In certain embodiments, a system may include one or more servers to, for example, operate a knowledge management system and/or repository, including databases. In certain embodiments, the system may also include, for example, remote terminals (e.g., workstations or computer terminals) for operating a search portal interface and knowledge management interface and may be similar to, for example, exemplary computing device 300 (FIG. 4). In certain embodiments, the various units of the system may be connected by a wired or wireless network (e.g., network 140 (FIG. 3)) such as, for example, the Internet. The search portal and the knowledge management interfaces may also be at the server and accessed remotely via the wired or wireless network or Internet.

In certain embodiments, the search portal interface may, for example, log(e.g., record or save) the searches or search sessions and views to a database (e.g., storage 130 (FIG. 3)) via a processor (e.g., controller 305 (FIG. 4)). The search portal interface may log or record, for example, the time of an event (e.g., a search or a view), the text of a search and/or any other factors that may affect the search such as, for example, the selection of content categories, content groups accessible to the user doing the search, or other factors. The search portal interface may also log or record a unique identification (ID) of any document viewed, information identifying the user doing the search, feedback from the user on the success of the search session and/or of a given article or search result, and information uniquely identifying the session.

The session information may be used to group all of the activity for a given user looking for a solution to a given problem. In certain embodiments, evaluation procedures or steps may be performed or conducted on whether or not the search sessions were a success. In certain embodiments, the success of a search session may be based, for example, on the number of articles viewed, the duration of the search session and/or feedback given by the user. For example, success may be defined by a user defining some heuristic such as, for example, defining any session with searches but no views as unsuccessful, define any session with a view where the search user rated the solution as good as a success or by using other heuristics coded into the system.

The success of a search may be explicit. For example, the user may mark, identify, or otherwise provide input to the system to indicate that a document was responsive or nonresponsive to the search performed. If an article is marked as nonresponsive to the search performed that search may be rated more negatively than a search in which the document was marked responsive. A user may provide input to the system that a search was good or bad (or another set of binary indications) or provide another non-binary rating regarding an overall search, instead of providing input regarding specific documents. In other embodiments, the success of a search may be implicit. For example, a user may perform a search, view a single document, and exit the search session. Viewing a document in a list of documents in a search result may include, for example, requesting that the system show the user the document by, for example, clicking or otherwise indicating a link to or summary of the document in the search result. Such a result may indicate that the user found the knowledge they were seeking by performing the search and the search session may be rated positively for usefulness or responsiveness. Alternatively, a user may perform a search or multiple searches, fail to view a single document and exit the search session. Such a result may indicate that the user did not find the knowledge they were seeking by performing the search or searches and the search session may be rated negatively or with a low rating for usefulness or responsiveness. Other ways of explicitly or implicitly defining the success of a search may be used. In certain embodiments, a knowledge management system may use only explicit methods, only implicit methods, or a combination of both explicit and implicit methods of defining the success of a search or search session.

In certain embodiments clusters of the searches or search sessions may be rated in a similar manner as the individual searches or search sessions. In certain embodiments, search sessions may be compiled into a plurality of search clusters based on a commonality of search terms used in each search or search session. Compiling the searches or search sessions into clusters may identify, for example, areas in which the knowledge management system is lacking in relevant or responsive knowledge on a topic, identify areas in which the knowledge management system has an overabundance of knowledge on a topic, or identify whether a particular document is useful, responsive or relevant to a search, or cluster of searches.

The determination of a success, rating, or number of documents found by a search or cluster, is typically based on the application of the searches or clusters to a set of documents, or the ongoing history of searches over a set of documents, such as a document database associated with the system performing the determination. A different set of documents, or a change in the set of documents associated with the system, may produce a different measure of success for each search or cluster.

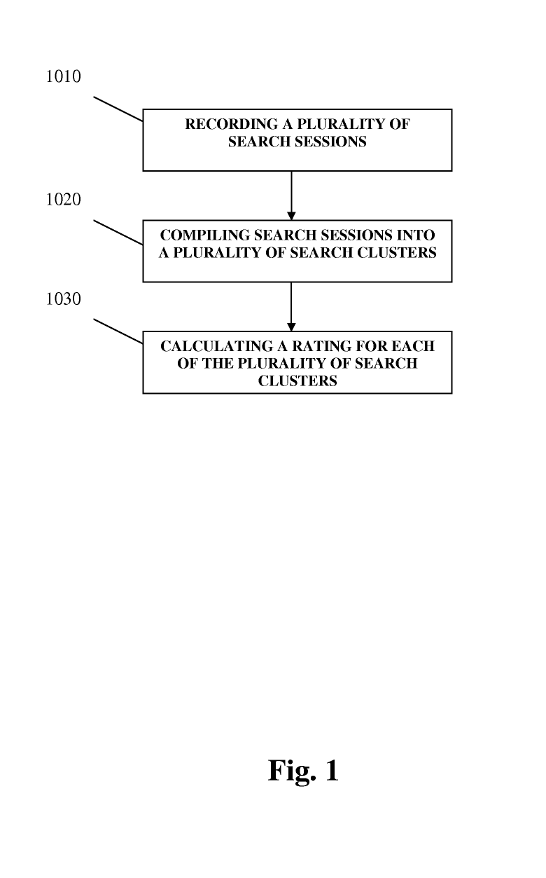

For example, reference is made to FIG. 1, which is flow chart illustrating a method of analyzing search sessions according to embodiments of the present invention. In operation 1010, a plurality of search sessions may be recorded. For example the time of each search session, the duration of each search session, the terms or phrases used in each search, whether or not a user viewed a search result, and/or whether the user indicated that a search result was, or was not, useful, responsive or relevant to the search query, may be recorded or logged. Other data may be recorded.

The search sessions compiled or grouped into a plurality of search clusters (operation 1020), for example based on a commonality of search terms used across sessions in each cluster. Compilation or grouping may be performed for example, using cluster analysis as known in the art to group search sessions together based on the similarity of search terms used, when each search occurred, or the duration of each search session. The plurality of search sessions may be grouped or compiled into clusters based on a single factor or multiple factors. Compiling the plurality of search sessions into clusters may be performed manually by a user or administrator initiating the cluster analysis, or it may be performed by the system automatically at regular intervals, or after each search.

In operation 1030 a rating may be determined or calculated for searches or for clusters of searches. For example, a rating, evaluation or ranking may be determined for each of the search clusters. This may be done, for example based on the success of the search session in yielding usable search results. The calculation of the rating may be performed manually by a user or administrator initiating the calculation, or it may be performed by the system automatically at regular intervals.

In certain embodiments, the calculation may be performed for each search in a search session, for each search session in a search cluster, or for each search cluster. Thus the rating for searches or clusters may be updated as more data is created, e.g., as users perform more searches using the clusters or searches. Thus operation 1030 may be an ongoing or iterative process.

Typically, the success rating is based on a known document database, e.g., a set of documents associated with the system, and thus a different set of documents may produce a different measure of success for each search or cluster.

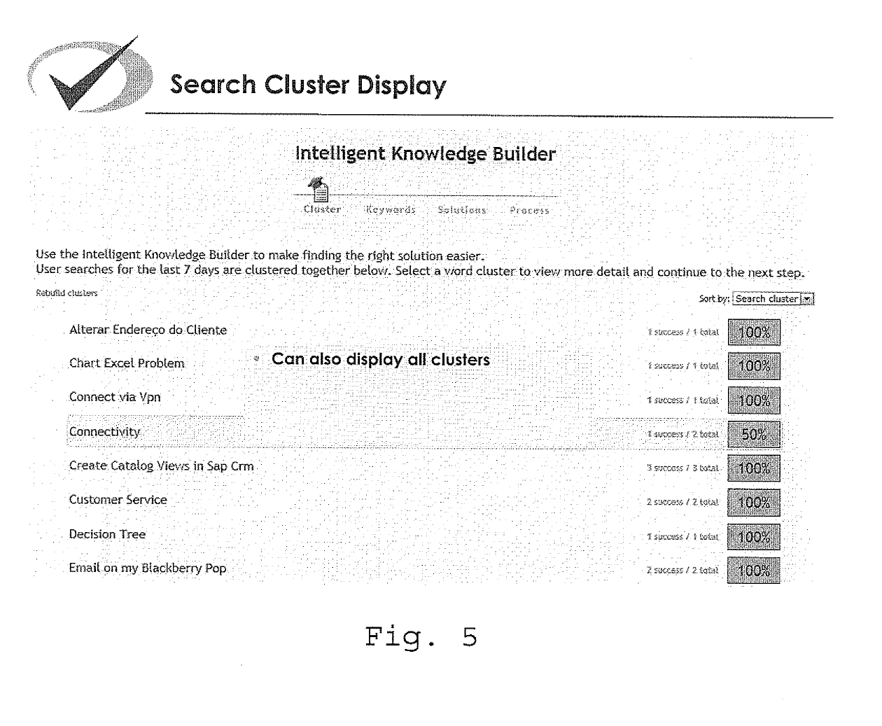

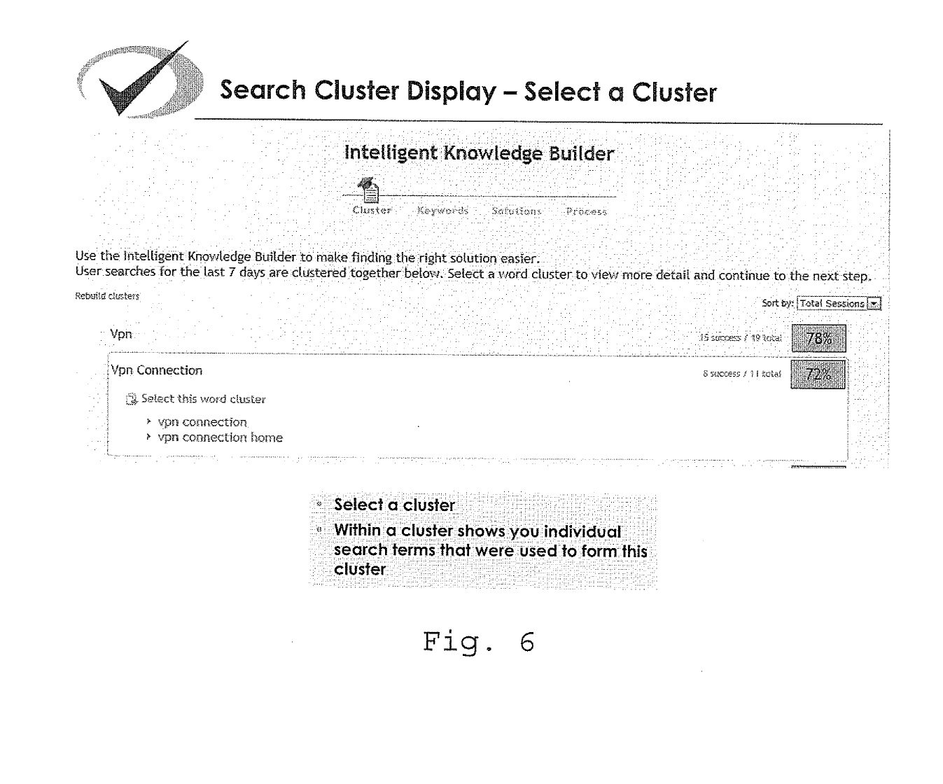

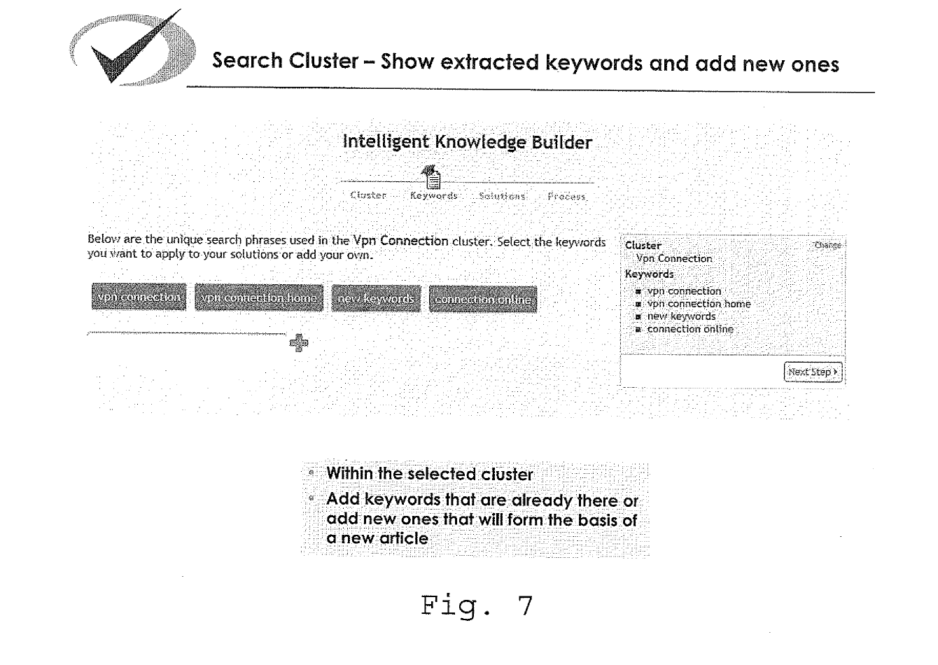

In certain embodiments, the plurality of search clusters may be compiled into an index, the index being weighted to assist a user in the creation of new content to address the need for content being searched for by the plurality of search sessions. In certain embodiments, the method may also include displaying or listing on a report the plurality of search clusters in order of how frequently each search session in each cluster obtained a negative result, or in order of a cluster rating, e.g., from lowest to highest (e.g., see FIGS. 5, 6 and 7). For example, the report may provide how frequently a user executed a search but failed to view any solution resulting for that search, or it may provide how frequently a user indicated that a solution was nonresponsive or irrelevant to the search. In certain embodiments, the method may also include listing a plurality of search results in order of how responsive or useful a search result is to each session in each cluster. Listing the search results in this way may be helpful in determining if the system contains sufficient knowledge for adequately answering the search queries represented by each cluster. A report may list clusters in order of rating, and allow a user to expand the information displayed by the cluster by for example clicking on the cluster. Expanding the cluster may include displaying the searches within the cluster, ranked by rating, or other information.

In response to this, a user may for example add documents to the system or database responsive to the least “useful” searches, as these documents may fulfill an unmet need. In certain embodiments, the method may include listing or displaying, for each cluster, at least one top search result matching the topics in each cluster. In some embodiments, the rating is calculated based on explicit user action, implicit user action or both explicit and implicit user action. For example, an explicit user action may include clicking a button (e.g., moving a pointing device to move an on-screen icon or cursor over an on-screen button, then clicking a button on the pointing device) or otherwise indicating that a search result or solution was responsive or nonresponsive to the search conducted. An example of an implicit user action may include conducting a search, viewing a single solution and exiting the search (e.g., a positive implicit user action), or conducting a search and not viewing a single solution resulting from that search (e.g., a negative implicit user action).

Listing or displaying results may be done, for example, on a monitor, such as a monitor 340 of user device 111. Reference is made to FIGS. 5, 6 and 7 which are example displays on a monitor, e.g., of a user computing device 111 (FIG. 3).

In certain embodiments, the rating may be calculated as a percentage or as a fraction. In other embodiments, the rating may be given as, for example, a letter grade (e.g., A, B, C, D or F). The rating may be calculated based on the percentage of times a user indicates, explicitly and/or implicitly, that a search yielded useful, relevant, or responsive search results. A threshold percentage may be used to indicate a letter grade in certain embodiments.

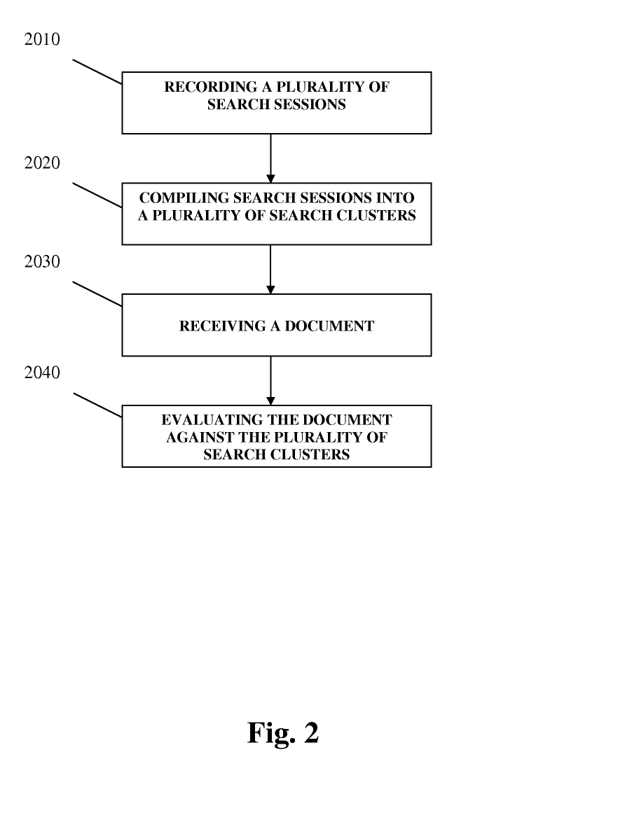

Reference is made to FIG. 2, which is a flow chart illustrating a method of evaluating the applicability of new content being added to a knowledge management system (e.g., document server 125) according to embodiments of the present invention. In operation 2010 a plurality of search sessions may be recorded. For example, the time of each search session, the terms or phrases used in each search, whether or not a user viewed a search result, and/or whether the user indicated that a search result was, or was not, useful, responsive or relevant to the search query may be recorded or logged. The indication may be implicit; e.g., a user requesting to view a document in a search result may be implicit input that a result was useful.

The sessions may be combined or compiled into a plurality of search clusters (operation 2020), for example, based on a commonality of search terms used across sessions in each cluster. For example, the search clusters may be compiled using cluster analysis as known in the art to group sessions together based on the similarity of search terms used, when each search occurred, or the duration of each search session. The plurality of search sessions may be compiled into clusters based on a single factor or multiple factors. Operation 2020 may be performed manually by a user or administrator initiating the cluster analysis, or it may be performed by the system automatically at regular intervals.

In operation 2030 a document may be received and evaluated against the plurality of search clusters (operation 2040) to determine for each search cluster how likely a search using the search cluster is to rank the document high in the search. For example, in operation 2030, a document may be received by or uploaded to the knowledge management system, authored or created on the knowledge management system or edited on the knowledge management system. The document may be for example received from a user or author, e.g., operating a terminal such as a computer 111.

In operation 2040, the document may be evaluated. For example, an evaluation may be by the system manually by a user or administrator initiating the evaluation, or it may be performed by the system automatically upon the system receiving a document (e.g., as in operation 2030). In certain embodiments, the evaluation may include using key words in the document, which may be determined or identified by the user or by the system, and comparing the key words against the terms and phrases used for each search in a cluster. If the evaluation determines that searches in the cluster are likely to find the document, or to rank the document high in search results, it may be determined that the document matches the search well. If the evaluation determines that searches in the cluster are not likely to find the document, or to rank the document low in search results, it may be determined that the document does not match the search well. The correspondence or match may be reported to or displayed to the user.

In certain embodiments, the method may include providing to an author of the document an estimate of how often the document will be searched for based on the evaluation against the plurality of search clusters. In some embodiments, the evaluation may include displaying or listing a cluster, or a number of search sessions compiled in the search cluster that the document is responsive to. Multiple clusters to which the document is responsive, or which find the document, may be listed or displayed, for example, ordered by how high the document appears in such a search, or another metric or ordering. The listing of a cluster or search session may include a list of searches or clusters, identified for example by terms or representative searches within the cluster, and corresponding data. The listing of a cluster or search session may include data for each cluster such as, for example, the search terms or phrases used in each cluster or session, how often searches within the cluster are performed, or if a user has obtained a useful, relevant, or responsive search result. In some embodiments, the data may include listing how high the document would rank among existing documents in response to a search session if the search session were executed by a user.

A method may include determining the usefulness of content in a document to a knowledge management system, including evaluating the content in the document against the rated plurality of search clusters to determine the usefulness of the content to the knowledge management system.

In the knowledge management interface a user may add a workflow, which may be defined as an interface for the knowledge author to aid him or her in the creation of new articles. The knowledge management interface may be operated by an exemplary browser system found on, for example, document server 125 and/or user computing devices 111A-D (FIG. 3). Such a workflow may be provided with a system, and need not be added by a user. In certain embodiments, the workflow may present to the author a list or index of clusters of search sessions that have similar search terms and articles viewed, and bring to the top of that list or index those clusters for which the search sessions were generally regarded or rated as unsuccessful or negative. In certain embodiments, this clustering may be performed using a number of standard algorithms, the most common being term-vector based clustering that may be performed by, for example controller 305 (FIG. 4) or other processor. In certain embodiments, the workflow may then present that information to the knowledge user. The user may use this information to draft a new article or document. For example, on seeing that a certain search cluster has a low success rate, the user may purposefully draft an article for that cluster, as the need that the cluster represents (users requesting documents relevant to terms) is not being met. It might be expected that an article or document created with that cluster in mind, or designed to be returned by a search from that cluster, would be high on a relevance list in search results for that cluster.

In certain embodiments, information may be presented to the knowledge user as a start of a new article by, for example, automatically populating the new article with, or adding to the article, the search terms or phrases from the searches and listing in a field of that new article solutions viewed and feedback given by users in that search session. For example, the user may view a cluster generally regarded or rated as unsuccessful and choose an option (e.g., click a button) to create a new article responsive to that cluster. The operation of choosing to create a new article may automatically add to the new article (e.g., populate) search terms or phrases commonly used within that cluster. The search terms and phrases added to the new article may help guide the knowledge user in writing the article to be responsive or relevant to the searches represented in the cluster. An article, as discussed herein, may be any document or knowledge being searched for.

In certain embodiments, a set of search results that cluster together without an obvious matching document can suggest a new document, in that the information from the searches may become, for example, the title, problem, and/or symptom of a new article to be added to the knowledge management system. For example, this new article may appear to the knowledge author in the same interface normally used to create a new article (e.g., the knowledge management interface), and the author may then modify the information populated into the article and save it into the database of the knowledge management system as a new document.

An embodiment of the invention my include evaluating content as part of knowledge adding and/or editing which would evaluate content of a document against existing sessions or clusters of sessions. In certain embodiments, the evaluation may be executed or run automatically by the knowledge management system (e.g., server 125) as an author is creating (e.g., drafting) or editing an article, be invoked automatically at a particular stage of authoring (e.g. upon saving an article), or be invoked manually by the author. For example, when a user is writing a new article or document, it can be vetted against or compared with searches. At optional parts of the authoring process such as, for example, saving, editing, clicking on an ‘evaluate button’, or continuously or semi-continuously as the author writes words or switches to a different field in the document he or she is editing, the processor or computer may take the article in the state it is currently in and evaluate it against past searches to determine the usefulness of the content. An example of the feedback given to the author might be “this solution currently ranks in the bottom ten percent of your solutions for usefulness against past activity” or “this solution would rank as the top solution and good match for 7 previous search sessions”. The user drafting the content may then use this information to determine if the content being created is desirable content (e.g., responsive to searches), if the content addresses a need for content, or if the content is redundant to other content on the system and, therefore, not desirable.

By clustering common sessions, an embodiment may produce for example a term vector for each cluster of sessions, plus a count of the number of sessions represented by each term vector, and this list of term vectors would form a term matrix or index. In some embodiments, the search sessions or clusters used to create this term matrix or index could also be filtered or weighted by, for example, time frame to potentially exclude irrelevant past usage. In some embodiments, the search sessions or clusters can also be filtered or weighted by, for example, explicit and/or inferred success of those sessions, so as to potentially focus on the evaluation of sessions against successful sessions, unsuccessful sessions or both.

In certain embodiments, when a new article or document is evaluated it may also be represented as a term vector, and may, for example, be weighted by different parameters in different fields of the document. In certain embodiments, this term vector may be applied as a search against the term index, which may generate similarity scores for each cluster of terms and the clusters may be sorted according to this similarity score. In certain embodiments, the scores may then be evaluated against a standard score or set of scores to judge the applicability of the various search clusters to the article being evaluated. The system (e.g., server 125) may then report to an administrator or content contributor on the number and percentage of search sessions in various ranges of similarities. For example, in certain embodiments, the system might report “8 search sessions representing 2 search topics rated as a good match for this article, ranking at the 10^{th} percentile of existing solutions, 20 search sessions representing 4 search topics rated as ok match for this article, ranking in 22^{nd} percentile of existing content.” The knowledge management system administrator or content contributor can then use this information to add or not add the content to the system, or possibly increase or decrease the search weighting this article should have based on past searching. In certain embodiments, the knowledge management interface may also present the option of looking at the search session details of the clusters evaluated as rating well against the content, which may potentially suggest, for example, keywords and alternate symptom phrases to add to the content which might enhance the search effectiveness thereof. As used herein, an alternate symptom phrase is a common search phrase used to search for a particular article, and thus being a good phrase to add to the content of the article. The modified document may then be feed back into the evaluation process, which would then present a new set of results for the modified content.

In other embodiments, the system may include an additional workflow for the evaluation of content already in the knowledge management system. For example, a user may run a report on a regular basis such as, for example, a report against all existing content or, optionally, against content that has not been used, viewed, rated as successful, or some other parameter based on usage, time frames of usage and/or time frames of authoring. The knowledge management system may then present a report of this information, which may be, for example, sorted by the scoring and/or filtered by when the article was created, last modified, viewed, etc. This report would allow an administrator of the system to more deeply analyze the content than simply looking at what articles have or have not been used. For example, it may often be the case that an article authored recently may not have been used, but may nonetheless score well against past search sessions. Additionally, this report may enable one to either individually or in bulk un-publish, delete, or lower the search weighting of content that is clearly not in demand, which has the effect of emphasizing content that is in demand and increasing the likelihood that searched for content is presented high in the search result listings.

Optionally, in certain embodiments, a system administrator or user may add search phrases or keywords suggested by the highest relevance search clusters to an article or document, which would improve the reported relevance scores of that article and therefore enhance the likelihood of the article being returned for similar searches.

One embodiment of the invention may include a knowledge management system, including a memory to store a plurality of search sessions and a processor to record a plurality of search sessions, the search sessions compiled into a plurality of search clusters based on a commonality of search terms used across sessions in each cluster and calculate a rating for each of the plurality of search clusters based on the success of the search session in yielding usable search results. In certain embodiments, the system may include at least one user computing device. In some embodiments, the system may include a search portal interface and/or a knowledge management interface. In some embodiments, the system may include a network. Example of a knowledge management system of certain embodiments may be described with reference to the following figures.

Reference is now made to FIG. 3, which is a block diagram of a knowledge management system 100 according to embodiments of the invention. System 100 may include one or more network(s) 140 (e.g. the Internet), and one or more user computing device(s) or terminals 111A, 111B, 111C and 111D connected to network 140. Each of devices 111A, 111B, 111C and 111D may include a world wide web (web) browser or other remote terminal software module 112 (shown only within device 111A). System 100 may include, for example, one or more web servers 115 (e.g., providing documents across the Internet), a document or application server 125, and a storage 130 operatively connected to document server 125. Computing device(s) 111A-D, web server 115, and server 125 may all communicate by and send signals to each other via network 140. Network(s) 140 may be or may include a private or public internet protocol (IP) network, the Internet, other networks, or a combination of networks.

User computing devices 111A-D may be client computing device(s) such as, for example, a computing device operated by an end-user viewing documents, editing documents, viewing web content, etc. Computing devices 111A-D may include, for example, personal computers, terminals, workstations, Personal Digital Assistants (PDAs), cellular phones, or other computing device of similar import.

Web server 115 and document or application server 125 may be or may include one or more suitable server computers as known in the art. Storage 130 may include, for example, a hard disk drive, a floppy disk drive, a Compact Disk (CD) drive, a CD-Recordable (CD-R) drive, a flash drive, or other suitable removable and/or fixed storage unit.

Web server 115, application server 125 and user computing devices 111A-D may include processor(s) and memory unit(s), and other units, as shown for example in FIG. 2.

Web server 115 may be a web server as known in the art and may, accordingly, support web sites, provide web pages or other content objects, handle hyper text transfer protocol (HTTP) and/or hyper text markup language (HTML), manipulate cookies or perform any operations related to a web server or application as known in the art. Web browser or terminal 112 may be any web browser, e.g., a commercial web browser or any module or application capable of receiving content objects and providing or presenting content to a user. Web browser 112 may receive and display, present or provide content received from web server 115, and application server 125. Web browser or terminal 112 may be a remote terminal program.

While different functions are described in the examples given as being performed by entities 111, 115, and 125, in other embodiments, the functionality may be performed by different units, and functionality may be combined. For example, one server (e.g., 115) may store documents, perform searches, and be directly accessed by a user. Searches, clustering, and other functionality may be provided by a processor at a user device 111A.

A server 125 in conjunction with a user device 111 may provide the functionality of methods described hereinabove. A server 125 may evaluate searches or clusters, create or compile clusters, evaluate documents against searches or clusters, report to users, and provide a user interface (e.g. via remote terminals 111), operate a search engine, search portal interface, or other search process (e.g., accessed via a user terminal) to search over a database (e.g., storage 130), or over documents maintained on the Internet. For example, in certain embodiments, a user may access a user device 111 to operate a browser 112, which accesses server 125 to search for documents, upload documents, etc. A user may access a user device 111 to create or edit a document or article (e.g., using a word processor or other document creation software module executed locally to user device 111 or executed on server 125).

Reference is made to FIG. 4, showing high level block diagram of an exemplary computing device 300 according to embodiments of the present invention. Any of devices 111A-111D, web server 115, and document or application server 125 as described with respect to FIG. 1 may be or include a structure similar to the example of computing device 300 shown in FIG. 2. Computing device 300 may include a controller 305 that may be, for example, a central processing unit processor (CPU), a chip or any suitable computing or computational device, an operating system 315, a memory 320, a storage 330, an input device 335 and an output device 340. A memory 320 may for example store data such as searches, search clusters, documents, etc., depending on the device in which the memory 320 is located.

Memory 320 may be or may include, for example, one or more of a Random Access Memory (RAM), a read only memory (ROM), a Dynamic RAM (DRAM), a Synchronous DRAM (SD-RAM), a double data rate (DDR) memory chip, a Flash memory, volatile or non-volatile memory, a cache, a buffer, or other suitable memory units or storage units.

Executable code 325 may be executed by controller 305 possibly under control of operating system 315. Executable code 325 may include, for example, browser 112, or software or code effecting various embodiments described herein. Storage 330 may be or may include, for example, a hard disk drive, a flash drive, a floppy disk drive, a Compact Disk (CD) drive, or other suitable removable and/or fixed storage unit.

Input devices 335 may be or may include a mouse, a keyboard, a touch screen or pad or any suitable input device. Output devices 340 may include one or more monitors, displays, speakers and/or any other suitable output devices. According to embodiments of the invention, servers 125, and 115 and user devices 111A-D as described for FIG. 1 may include all or some of the components comprised in computing device 300 as shown and described herein.

Reference is made to FIGS. 5-7, which are example displays, e.g., on a monitor of a user computing device 111, according to embodiments of the present invention.

Embodiments of the invention may include an article such as a computer or processor readable medium, a machine-readable medium, or a non-transitory computer or processor storage medium, such as for example a memory, a disk drive, or a USB flash memory, encoding, including or storing instructions, e.g., computer-executable instructions, which when executed by a processor or controller, carry out methods disclosed herein. For example, a storage medium such as memory 320, computer-executable instructions such as executable code 325 and a controller such as controller 305 may be used to carry out methods described herein.

Various embodiments are described herein, with various features. In some embodiments, certain features may be omitted, or features from one embodiment may be used with another embodiment. Modifications of embodiments of the present invention will occur to persons skilled in the art. All such modifications are within the scope and spirit of the present invention as defined by the appended claims.

What is claimed is:

1. A method of analyzing search sessions, the method comprising:
recording a plurality of search sessions for electronically stored documents, the search sessions compiled into a plurality of search clusters based on a commonality of search terms used across sessions in each cluster; and
calculating a rating for each of the plurality of search clusters based on the success of the search session in yielding usable search results.

2. The method according to claim 1, comprising listing the plurality of search clusters in order of how frequently each search session in each cluster obtained a negative rating.

3. The method according to claim 2, comprising automatically populating a new document with terms used in at least one search result that obtained the negative rating.

4. The method according to claim 1, comprising listing a plurality of search results in order of how responsive a search result is to each search session in each cluster.

5. The method according to claim 1, comprising listing for each cluster at least one top search result matching the topics in each cluster.

6. The method according to claim 1, wherein the rating is calculated based on explicit user action, implicit user action or both explicit and implicit user action.

7. The method according to claim 6, wherein the rating is calculated as a percentage.

8. The method according to claim 6, wherein the rating is a fraction.

9. The method according to claim 1, wherein the electronically stored documents are text documents.

10. A method of evaluating the applicability of a document being added to a knowledge management system, the method comprising:
recording a plurality of search sessions, the search sessions compiled into a plurality of search clusters based on a commonality of search terms used across sessions in each cluster;
receiving a document; and
evaluating the document against the plurality of search clusters to determine for each search cluster how likely a search using the search cluster is to rank the document high in the search.

11. The method according to claim 10, comprising providing to an author of the document an estimate of how often the document will be searched for based on the evaluation against the plurality of search clusters.

12. The method according to claim 10, wherein the evaluation comprises listing search sessions the document is responsive to.

13. The method according to claim 10, wherein the evaluation comprises listing how high the document would rank among existing documents in response to a search session.

14. The method according to claim 10, wherein the document is a text documents

15. A knowledge management system, the system comprising:
a memory to store a plurality of search sessions; and
a processor to:
record a plurality of search sessions, the search sessions compiled into a plurality of search clusters based on a commonality of search terms used across sessions in each cluster; and
calculate a rating for each of the plurality of search clusters based on the success of the search session in yielding usable search results.

16. The knowledge management system according to claim 15, comprising at least one user computing device.

17. The knowledge management system according to claim 15, comprising a search portal interface.

18. The knowledge management system according to claim 15, comprising a knowledge management interface.

19. The knowledge management system according to claim 15, comprising a network.

20. The knowledge management system according to claim 15, wherein the processor evaluates the document against the plurality of search clusters to determine for each search cluster how likely a search using the search cluster is to rank the document high in the search.
